(19) United States
(12) Patent Application Publication
(10) Pub. No.: US 2006/0219069 A1
(43) Pub. Date: Oct. 5, 2006

(54) Food product slicing apparatus and method

(75) Inventors: Gary R. Skaar, Marshall, WI (US); Timothy T. Watson, Waunakee, WI (US); John A. Hirschey, Middleton, WI (US); Jennifer L. Tomey, Merom, IN (US); Norman C. Abler, Madison, WI (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 11/098,393

(22) Filed: Apr. 5, 2005

(51) Int. Cl. B26D 7/00

(52) U.S. Cl. 83/13; 83/167

(57) ABSTRACT

An apparatus, and method of its use, for slicing food products, particularly elongated food products, in which the apparatus has a housing enclosing a rotatable slicing blade, and a sleeve which is mounted in a housing sidewall. The sleeve provides a passageway through which a food product passes and receives a treatment along its outer surface. Other additional and/or alternative features for enhancing or sustaining the cleanliness within the slicing housing also are provided, which include use of overpressure within the housing interior, introduction of HEPA-filtered gas or air therein, delivery of an antimicrobial agent therein, and/or providing interior housing wall surfaces having a surface finish (RMS) not exceeding 32 microinches. The slicing apparatus, and its method of operation, provides reliable, accurate continuous slicing capability while requiring less cleaning.

### FIELD OF THE INVENTION

This invention relates to an apparatus and method for slicing food products, particularly food products in elongated form.

### BACKGROUND OF THE INVENTION

Many food products, such as bologna, sausage, luncheon meat, salami, ham loafs, and other food products, are initially prepared in an elongated form of substantially uniform cross-section of so-called logs of meat that are fed through a high-speed slicer to provide substantially uniform slices, which are stacked and packaged for commercial distribution and sale.

In one typical slicer apparatus that has been used in high volume production, each elongated food product is placed in a receiving channel with a high-speed rotating blade at one end of the channel operable for movement transverse to the lengthwise dimension of the log, towards which the log is fed. The feeding is achieved by a pushing member, which engages against the end of the log opposite the blade, and pushes the log towards the rotating slicer blade. Hold-down plates or shoes have been used to apply pressure to the top surface of the log near the slicing blade so that the product properly engages the blade during slicing. The blade is used to make a series of transverse cuts through the log as it is advanced towards it, providing slices of the food product.

As slices are cut from the log, they fall onto a stacker, such as a pair of rotating paddle wheels, the rotation of which is timed to collect the slices in stacks of desired weight, and upon rotating further, to drop the stack of slices onto a conveyor. After all or substantially all of a log is sliced, any remaining unsliced portion of the food product is removed, and another food product is placed into the receiving channel for slicing. Undesirable residues from the slicing operations and feeding of the food product can collect in and around exposed surfaces and parts in the vicinity of the slicing blade.

### SUMMARY OF THE INVENTION

An apparatus and its method for slicing a food product log are provided. In one embodiment, the slicing apparatus includes a housing enclosing a rotatable slicing blade, and a sealing and cleaning structure is mounted to a housing sidewall which provides a passageway through which a food product log, such as a meat log, is fed into the housing and receives a treatment along its outer surface. Cleaner slicing conditions inside the housing can be maintained by provision of the sealing and cleaning structure as a component of the slicing apparatus.

In one particular embodiment, the sealing structure comprises a sleeve having channels formed in its interior that provide and direct a flowable material along the outer surface of the food product as the product is advanced through the sleeve towards the slicing blade. The flowable material has properties selected for treating the outer surface of the food product. In one particular embodiment, the flowable material is a source of thermal energy, such as steam or hot air. In another particular embodiment, the flowable material is a gaseous chemical substance, such as ozone.

In another embodiment, at least a portion of the sleeve which extends into the interior space of the housing has a construction which allows radiant energy to be transmitted to the food product log therein. The radiant energy can be laser light, ultraviolet light, infrared radiation, and so forth, received from a radiant energy source outside the sleeve and that is transmitted to the outer surface of a food product log passing through the sleeve.

In one embodiment, the sleeve has a passageway having a cross-sectional geometry which is approximately the same shape as that of the food product advanced therethrough. The food product thus may be retained in position along its line of advancement towards the slicing apparatus by the solid continuous interior surfaces of the sleeve passageway without the need for moving mechanical parts, such as hold-down members or shear bars, and so forth. The conformational preselected shapes of the sleeve and food product leave less intervening gap space available for possible incursion of outside air through the sleeve passageway into the housing as food products are advanced through the sleeve. Sleeve arrangements such as these may be used to reduce microbial load or provide another surface treatment on the outer surface of the food product before slicing.

In a further embodiment, a pushing device also is provided outside the slicer housing for pushing the meat log, and a guiding device for guiding the meat log, towards and through the sealing and cleaning structure into the slicing region of the slicing apparatus.

In other embodiments of the slicing apparatus, which may or may not separately involve the use of the above-indicated sealing and cleaning sleeve per se as the particular meat log introduction means into the housing, the cleanliness of the interior surfaces and slicing equipment enclosed within the slicer housing is addressed in other unique and advantageous manners. For instance, in another embodiment, the interior space of the slicing housing is purged with inert air or gas at a rate and pressure effective to overpressurize the housing interior space and create a positive pressure condition inside the housing relative to atmospheric pressure conditions outside the housing. This assists in preventing incursion of outside air into the housing that might carry suspended particles, microbes, or substances into the housing. To further ensure cleanliness within the housing space, the pressurizing gas may be filtered before its introduction inside the housing, e.g., by using a high performance air filter such as a High-Efficiency Particulate Air (HEPA) filter.

In yet another embodiment, the sidewall and other exposed interior wall surfaces of the housing are provided having a smooth surface finish not exceeding 32 microinches, excluding the sleeve and slicing blade mount through the sidewall. This reduces the opportunities for particles, microbes, debris and residues to be harbored inside the housing around sharp edges and/or in small crevices, which helps to ensure clean and tidy slicing conditions.

In another embodiment, an antimicrobial agent delivery assembly is provided which delivers an antimicrobial agent to interior wall surfaces of the housing. The antimicrobial agent delivery assembly may be, for example, an antimicrobial liquid chemical sprayer or fogger, an antimicrobial gas dispenser, ultraviolet lights, infrared lamps, lasers, a steam or hot air delivery system, conductive heaters, individually or any combination thereof.

The slicing apparatus, and its method of operation, keeps a meat log clean at least until after it is sliced and discharged from the apparatus by sealing and/or keeping clean the equipment and air/gas to which the food is exposed or contacts inside the slicing housing. The slicing apparatus therefore can provide reliable, accurate continuous clean slicing capability.

### BRIEF DESCRIPTION OF THE DRAWINGS

FIG. 1 is a side elevation view of a slicing apparatus according to an embodiment of the invention;

FIG. 2 is a plan view of the slicing apparatus of FIG. 1;

FIG. 3 is a side elevational view, partly in section, of a paddle box included in the slicing apparatus shown in FIG. 1;

FIGS. 4, 5, and 6 are sectional views of the blades of the paddle showing the position of the blades during receipt of additional slices under low speed; and upon completion of the low speed rotation and immediately before initiating a higher speed rotation to drop the stack onto a conveyor; and at the beginning of stack formation after completion of the higher speed rotation; respectively.

FIG. 7 is a side perspective view of a slicing housing region of the slicing apparatus of FIG. 1;

FIG. 8 is an enlarged view of encircled area A in FIG. 7;

FIG. 9 is an enlarged view of encircled area A in FIG. 7 according to another embodiment;

FIG. 10 is a perspective view of a steam sleeve according to a first embodiment having multiple steam flow channels and generally D-shaped openings, which may be used as the sleeve in the slicing apparatus according to FIG. 1;

FIG. 11 is a side elevation view of the steam sleeve of FIG. 10 with a food product being advanced therethrough via an advancement mechanism;

FIG. 12 is a section view taken along line 12-12 of FIG. 11;

FIG. 13 is a section view taken along line 13-13 of FIG. 11;

FIG. 14 is a perspective view of a pusher device of the advancement mechanism;

FIG. 15 is a sectional side elevation view of the pusher device of FIG. 14;

FIG. 16 is a diagrammatic flow chart depicting a product treatment cycle;

FIG. 17 is a perspective view of a steam sleeve according to a second embodiment having multiple helical flow channels;

FIG. 18 is a side elevation schematic view of the steam sleeve of FIG. 17 showing multiple helical flow channels;

FIG. 19 is a side elevation sectional view of the steam sleeve of FIG. 18;

FIG. 20 is a section view taken along line 20-20 of FIG. 19;

FIG. 21 is a section view taken along line 21-21 of FIG. 19;

FIG. 22 is a section view taken along line 22-22 of FIG. 19;

FIG. 23 is a section view taken along line 23-23 of FIG. 19;

FIG. 24 is a perspective view of a steam sleeve according to a third embodiment having multiple helical flow channel;

FIG. 25 is a side elevation section view of the steam sleeve of FIG. 24;

FIG. 26 is a section view taken along line 26-26 of FIG. 25;

FIG. 27 is a section view taken along line 27-27 of FIG. 25;

FIG. 28 is a plot showing a predicted thermal model of the temperature at depths from the surface of the food product compared to travel time through the steam sleeve; and

FIG. 29 is a diagrammatic side elevation view of the steam sleeve of FIG. 24 positioned for use with a slicing mechanism.

The figures are not necessarily drawn to scale. Similarly numbered elements in figures represent like features unless indicated otherwise.

### DETAILED DESCRIPTION OF THE PREFERRED EMBODIMENTS

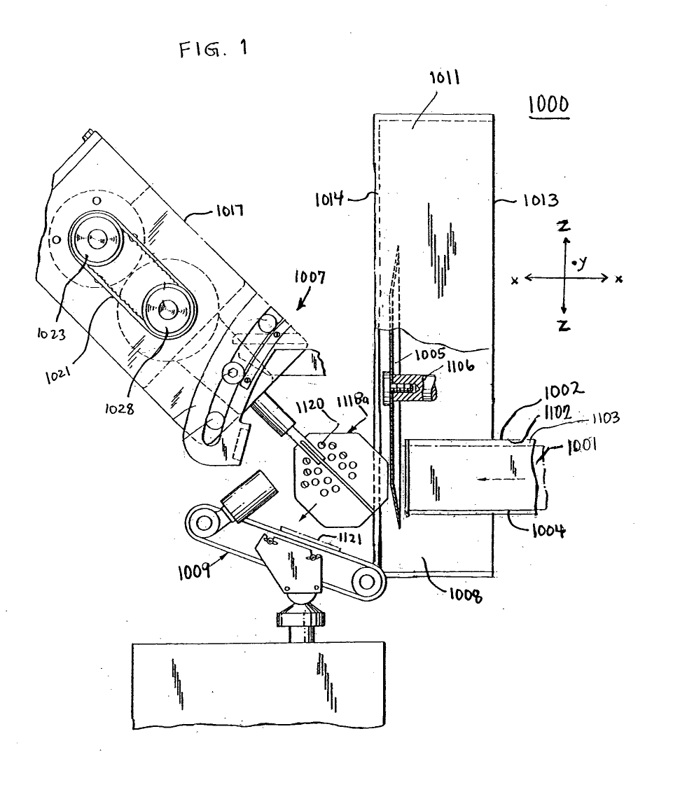

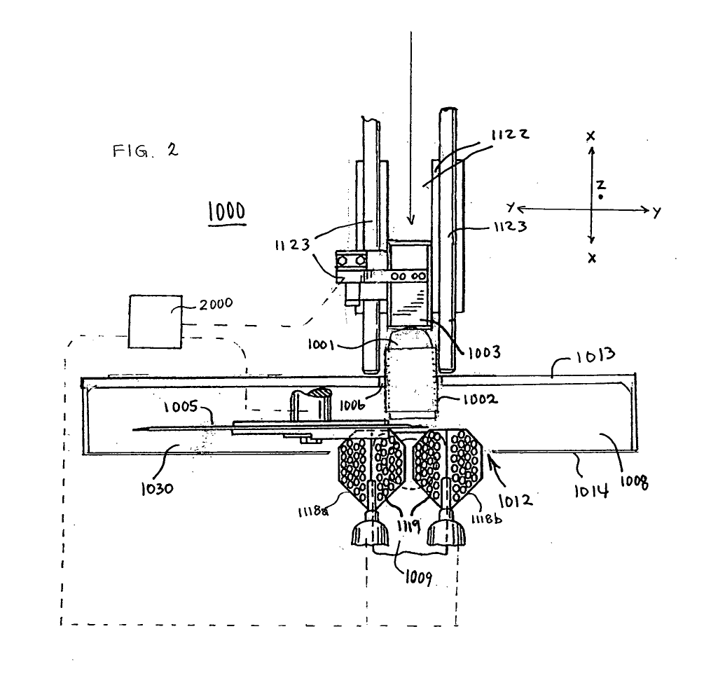

Referring to FIGS. 1-2, an apparatus 1000 is illustrated for slicing an elongated food product 1001, such as a generally cylindrical log of luncheon meat, in a single continuous operation. The elongated food product 1001 as illustrated is supported and advanced by a pusher 1003 to the slicing blade 1005 in order to be sliced and discharged onto a stacker 1007, and eventually a conveyor 1009. The slicing blade 1005 is partly encased in a protective housing 1011, which has a discharge opening 1012 at its rear side through which slice receiving paddles 1118a and 1118b of the stacker 1007 can be advanced and retracted. The housing 1011 includes a front sidewall 1013 and a rear sidewall 1014, which may be connected by a hinge or comparable component permitting the parts to be opened and closed as pivoting to form an enclosure defining an interior space in which the slicing blade 1005 is housed. In the illustrated embodiment the slicing apparatus 1000 is arranged such that food product 1001 is fed to the slicing blade along a substantially horizontal direction x-x, which is oriented substantially perpendicular to the lateral direction y-y and the vertical (gravitational) direction z-z. The meat log 1001 also could be inclined toward the blade 1005 to employ gravity assistance as it is being fed for slicing. In this non-limiting illustration, a sleeve 1002 is mounted in a through-hole 1006 in the front sidewall 1013 of the housing. Preferably, the sleeve 1002 has a cylindrical wall 1102 defining an annular internal passageway 1103 through which the cylindrical log of food product passes from outside-to-inside the housing and receives a treatment along its outer surface. In this manner, the sleeve 1002 effectively supports and directs the food product 1001 to the slicing blade 1005 in proper alignment, and maintains the alignment, as the product is advanced through the slicing zone. The sleeve maintains the alignment of the food product via a conformably-fitting cross-sectional sizing provided relative to the log of food product, which inhibits movement of the log in the y-y and z-z directions. The sleeve 1002 avoids the need for hold down plates or shoes within the housing to hold down the food product. At the same time, the sleeve is adapted to permit treatment of the outer surface of the food product as it passes through the sleeve to further ensure the cleanliness of the slicing operation and equipment. The sleeve 1002 is mounted as a unitary part in a sidewall through-hole 1006 provided in the front sidewall 1013 of the housing 1011. The sleeve 1002 may be removably mounted therein in a substantially air-tight manner in one implementation. In a particular arrangement, the sleeve is mounted on the sidewall by air-actuated lugs. The sleeve may be removed from the apparatus for immersion cleaning and then re-installed. Other details and manners of operation of the sleeve are provided infra.

Although a sealing sleeve is illustrated and described in detail herein in a preferred embodiment as the particular introduction means used to convey the meat log from outside to inside the slicer apparatus housing, it will be appreciated that the invention is not necessarily limited to usage of the sleeve to the extent other alternative or additional unique cleaning features are provided with the slicing apparatus which are described herein. For example, the meat log introduction means may be a standard hold-down shoe assembly or similar assembly in lieu of the sleeve in such other situations.

Referring again to FIG. 2, the food product 1001 is continuously fed forwardly by a pusher 1003 and each cycle of rotation of the blade 1005 produces another slice. A support channel 1122 located outside the housing 1011 may be used to support and guide the bottom and sides of the food product 1001 as it is advanced towards the slicing region by the pusher 1003. The pusher 1003 has movement provided by any suitable means, such as a carriage assembly 1123, which may be motor driven to travel back and forth on guide rails or screws thereof. The pusher 1003 itself may include a gripping means, such as a suction cup connected to a source of vacuum or other gripping means (not shown), which releasably grips a butt-end of the food product. Movement of carriage assembly 1123 may be controlled by controller 2000, which may be an electronic controller such as a servo-drive controller, which also controls the rotary movement of the slicer blade and paddle stacker in a synchronized and integrated manner described herein.

The slicing blade or knife 1005 may be a conventional type of rotary cutter blade and is in the form of an eccentric disc or dished blade, which is adapted to be rotated at relatively high speed. The rotating involute shape presents an advancing cutting edge for slicing the food product. The blade may be dished to allow clearance for advancing the food product during the slicing cycle. The blade 1005 is mounted at the end of a rotatable shaft 1006 passing through housing sidewall 1013, and is suitably journalled. The shaft 1006 in turn may be driven by a motor through a suitable drive mechanism (not shown), located outside the housing 1011. Such blade motor and mechanism may be interconnected and synchronized with the continuous movement of the pusher for the food product to assure uniform thickness of the slices. There also may be an interconnection provided between the speed of feed of the pusher 1003 and the conveyor 1009 in order that the speed of the feed of the pusher can be adjusted to correspondingly change the slice thickness and thereby maintain the weight of the stacked slices within the prescribed limits.

A paddle stacker 1007 is located adjacent to the discharge end 1012 of the slicing housing 1011 for receiving slices discharged therefrom. A stack conveyor 1009 or other stack receiving means is situated below the paddle stacker 1007, and the open or unwalled bottom of the housing, to receive thereon stacks of sliced product transferred, i.e., dropped, by the paddle stacker 1007.

The paddle stacker 1007 may be driven in timed relationship with knife shaft 1006 of the slicing blade 1005, and receives slices of the product, collects them in a stack, and, after the blade 1005 has cut the last slice of a stack, deposits the stack on the conveyor 1009. The stacker 1007 includes a box 1017 from which a pair of paddles 1118a and 1118b are ordinarily disposed in a slice receiving position below the slicing blade 1005. When a preselected number of slices of food product has been stacked on these paddles 1118a and 118b, the paddles are actuated to deposit the stack on a conveyor 1009.

The paddle stacker 1007 may be moved inwardly and outwardly, and also vertically up and down, with respect to the slicing housing, by conventional adjustment means. Paddles of the stacker are partly inserted inside the slicing housing 1011 via the discharge opening 1012 provided on the rear housing sidewall 1014. As shown in FIG. 2, the pair of cooperating paddles 1118a and 1118b of paddle stacker 1007 comprise slice-receiving blades 1119 on each respective paddle. The paddles 1118a and 1118b may have a conventional construction in which the slice receiving blades on each paddle are substantially equidistantly spaced apart, such as about 120 degrees apart in the case of three blades provided on each paddle. Both paddles 1118a and 1118b may include a series of apertures 1120 in each of their blades for purposes of increasing their slice gripping and retentive ability to thereby avoid sliding of the lowermost slice of the stack as it is thrown by the blade.

In a conventional manner, the paddles 1118a and 1118b may be motor driven to rotate, one in a clockwise direction and the other in a counter-clockwise direction such that adjoining blades of the paddles can cooperate to form a common intervening support surface upon which slices may be stacked, and eventually upon their further rotation downward, the blades move far enough apart as they continue to rotate to permit the stack 1121 to be dropped down upon the underlying conveyor 1009. The paddles continue to rotate to bring successive pairs of paddle blades through the stacking and transferring region.

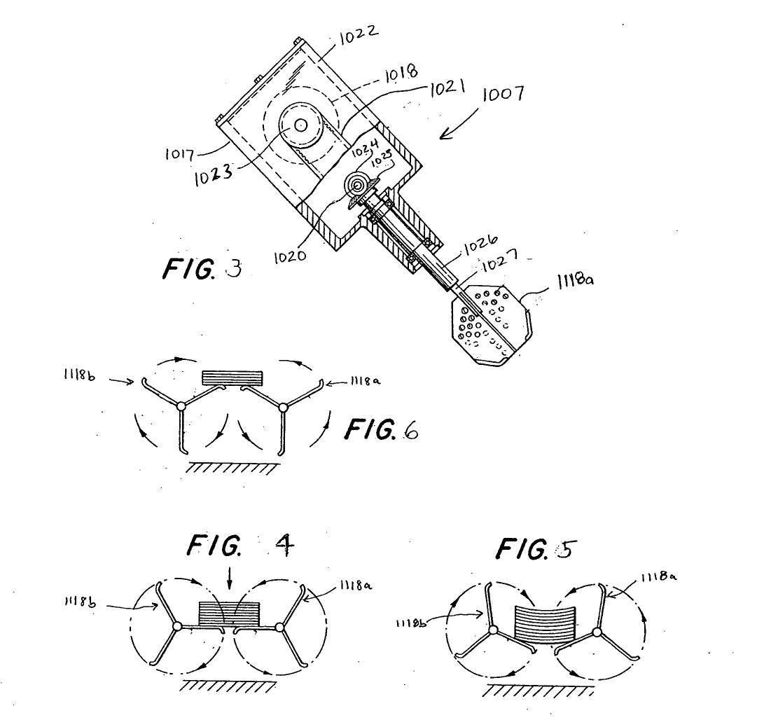

Referring to FIG. 3, a motor 1018 disposed within a housing 1022 of paddle box 1017 may rotate the paddles 1118a and 1118b of the paddle stacker 1007 through a conventional assembly. For instance, motor 1018 may drive a pulley 1023, which drives another pulley 1028, which is seen in FIG. 1, using a timing belt 1021 running over the pair of pulleys. Pulley 1028 is affixed to and drives a shaft 1020 passing through the housing 1022 from one side to the other. Referring to the drive assembly provided for paddle 1118a, a bevel gear 1024, which is connected to shaft 30, engages bevel gear 1025 which is operably connected to paddle holder 1026 to rotate the holder. The paddle holder 1026 has a bore to receive a mounting post 1027 of paddle 1118a. It will be appreciated that a similar gearing and paddle holding arrangement is also provided for paddle 118b. For instance, a gear similar to gear 1024 also may be connected to shaft 30 at a location suitable to engage a separate bevel gear similar to gear 1025, and so forth. In this illustration, control means 2000 is provided for coupling the motor and paddle stacker, and actuating the motor in the timed manner generally described above. As indicated, the control means also can control movement of the carriage assembly in a coordinated manner with the slicer and paddle stacker. The coupling means may be a cam rotatable by the motor rotating the paddles, and electric switches, which may be engaged by the cam, may be provided which actuate the motor for high or low speed, such as using an arrangement described, for example, in U.S. Pat. No. 3,933,066, which descriptions are incorporated herein by reference.

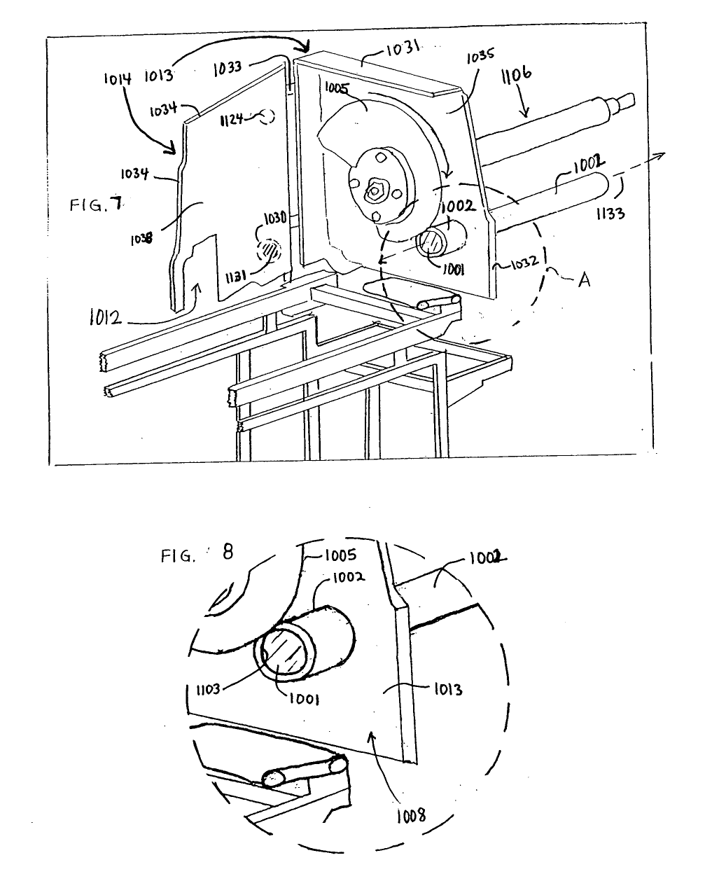

The motor 1018, which may be, for example, a low inertia D.C. motor, may be used to rotate the paddles of the paddle stacker at constant speed or different speeds during slice stacking and transferring. Referring to FIGS. 4-5, for instance, the motor may be used to drive the paddles 1118a and 1118b in a dual speed manner in which the paddles are driven at relatively lower speed as the slices are being stacked on such paddles (FIG. 4), and at relatively higher speed when the desired size of stack has been achieved and is desired to transfer the stack to the conveyor via gravity (FIG. 5). When the motor drives at lower speed it may be synchronized with the rate of advance of the slicing feeding means. When a desired stack size has been achieved, the motor may be actuated, via the controller 2000, to rotate the paddles 1118a and 1118b at higher speed to transfer the stack to the conveyor and bring the paddles back to the lower speed position ready for reception of slices for building another stack (FIG. 6).

In this illustration, the controller 2000 is used to integrate and synchronize movement and action of the pusher control, knife control, and stacker control. The stack conveyor 1009 may be used to transfer the stacked sliced to a packaging unit or other applicable processing unit. The conveyor may be a weigh-while-convey type of device for verification of the proper stack weight.

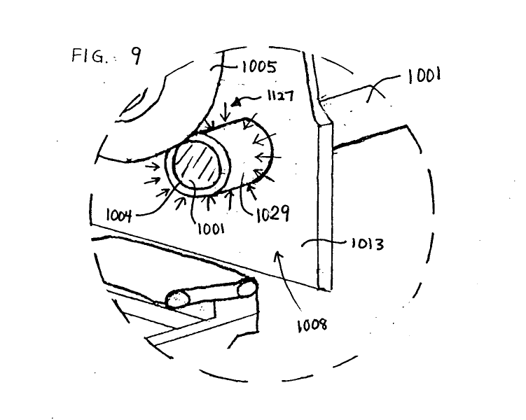

Referring to FIGS. 7-8, the housing 1011 is shown in an opened configuration in which the rear sidewall 1014 has been pivoted or swung open from front sidewall 1013 via hinge 1033. In this illustration, the front sidewall 1013 has an L-shape flange 1031 that extends along its top and back ends and another flange 1032 at its front end, which both extend rearward from a substantially vertically-oriented major face 1035 of front sidewall 1013, which receive a corresponding flange 1034 that extends along the top and front ends of the rear sidewall 1014, which extend forward relative to a substantially vertically-oriented major face 1038 of the rear sidewall, to provide an enclosure for the slicing blade 1005. An integral stop or abutment, not shown, can be provided inside the L-shaped portion(s) of front sidewall 1013 and rear sidewall 1014 to delimit the extent of movement of the rear sidewall 1014 possible towards the blade 1005. A gap 1030 is maintained between the rear sidewall 1014 and the blade 1005 in the closed housing during slicing operations, as shown in FIG. 2. The housing 1011 has a cut-out provided in the rear sidewall 1014 to form discharge opening 1012 for introduction of a stacker, as previously described, and the bottom of the housing is open to the exterior space and an underlying conveyor. The number of machine parts used to assemble the slicing housing and product feed assembly thereof are kept to a relatively small number, and integration of structural parts into single parts where practical also reduces the number and surface area of mating surfaces.

The direction of rotation of the involute blade 1005 is indicated in FIG. 7. The portion of the blade 1005 having the greatest radius serves to slice the leading edge of the product while the dished portion, or a portion of the blade having a sufficiently smaller radius, provides clearance for the advancing food product to be fed forwardly as the blade continues to rotate after a slice is cut, thereby permitting the initiation of the next slicing cycle. The blade also may have a known configuration in which the slicing blade has a generally concave non-severing body portion and a severing flat top surface having an average width of at least about 0.1 inch.

The sleeve 1002 has a central axis 1133, which is generally aligned with the horizontal path of the elongated food 1001 as it passes through the sleeve 1002. The cross-sectional shape of the sleeve passageway may be substantially matched with the contour of the perimeter of the food product such the product passes through it in a closely fitting yet non-obstructed manner. Accordingly, although an annular passageway 1103 is shown, for meat logs with other cross-sectional configurations, the passageway can be formed with a similar configuration. The sleeve guides and maintains the feeding alignment of the food product to the slicing blade through a series of successive slicing cycles performed on a food product without the need for assistance from hold-shoes or shear bars, and their mounting components, within the housing. The sleeve also is adapted for performing treatments on the outer surface of the food product in various active and/or passive manners, as described in more detail hereinafter.

The interior space 1008 of the housing 1011 may be purged during slicing operations by creating a positive pressure condition inside the housing relative to atmospheric pressure conditions outside the housing. For overpressurization, a gas supply system (not shown) is provided which is operable to feed gas, such as an inert gas or air, into the interior space of the housing at a rate and pressure effective to create a positive pressure in the housing interior space relative to ambient pressure conditions outside the housing. The overpressure condition created in the housing provides forced air that may exit the housing through openings such as discharge opening 1012, the unwalled or open bottom of the housing under which the conveyor is positioned, and/or any gap between the product and sleeve passageway, and so forth. This assists in minimizing the incursion of air into the housing from outside the housing that might carry suspended particles, microbes, or other substances into the housing.

To further optimize cleanliness within the housing space, the pressurizing gas may be filtered before its introduction inside the housing, e.g., by passing it through one or more air or gas filters. The air or gas filter or filters used may be, for example, a standard dust filter, a HEPA filter, and/or an activated carbon filter. In one particular embodiment, a HEPA (“High-Efficiency Particulate Air”) filter is used as the sole filtration unit. HEPA filters may be used which are known that are used for high-efficiency filtration of airborne dispersions of ultrafine solid and liquid particulates such as dust and pollen, radioactive particle contaminants, and aerosols. The efficiency of a HEPA filter is standardized as being at least 99.97% when challenged by particles of dioctylphthalate (DOP) having a size of 0.3 microns in diameter.

If such housing overpressurized conditions are not provided, the size of the openings provided for the paddle box and the housing bottom may be reduced to an extent that still permits functionality but effective to restrict the amount of air flowing in an out slicer housing regions.

To further optimize the cleanliness and tidiness of the housing interior during slicing operations, the interior wall surfaces of the housing sidewalls, and other exposed interior surfaces of the housing, may be machined or are otherwise smoothened to have a high surface finish, and particularly a surface finish not exceeding 32 microinches, excluding the sleeve and slicing blade mount through the sidewall. This reduces the opportunities for particles, microbes, debris and residues to be harbored or collect inside the housing, and particularly around sharp or protruding edges and/or in small crevices, voids, or holes, which helps to ensure clean and tidy slicing conditions.

For purposes herein, “surface finish” refers to a measure of the roughness of the surface of a housing structural component surface specified as the root mean squared (RMS) value, i.e., the standard deviation of the arithmetic mean value Ra. The average roughness (Ra) is measured using a surface profilometer. Contact and non-contact type microfinish indicators suitable for this purpose are commercially available, such as a profilometer. Ra is the arithmetic mean of the departures of the surface profile from the mean line. Ra is determined as the mean result of several consecutive sampling lengths.

The housing sidewalls 1013 and 1014 may be sheet metal construction, such as aluminum or steel sheet construction. To provide the high surface finish, the internal housing parts and surfaces may be initially finished to an RMS value of 125 microinches or less by pneumatic buffing. All sharp edges on the housing interior are may be broken and removed, particularly to a maximum radius of no more than 15 microinches. No bolt or screw heads may be left protruding into the housing interior space. Bolt holes, screw holes, or other openings in the housing sidewalls, other than those described infra having the indicated functions, are generally avoided. The housing sidewall parts may be mechanically stress-relieved and straightened before machining. Smooth welds may be formed around all interior joint corners of the sidewall parts, and any joints that may be used in mounting the sleeve in the front sidewall. The welds should be continuous, smooth, clean and free of pin holes and porosity. The welds also may be cleaned to remove discoloration, such as by using an abrasive wheel like SCOTCH-BRITE wheels, commercially made by 3M, Saint Paul, Minn. To provide the final finish, all interior surfaces and welds may be ground and/or sanded to an RMS value of nor greater than 63 microinches. Then, the entire part may be passivated and electropolished to a RMS value of no more than 32 microinches. Also, vacuum impregnation may be provided with anaerobic curing compounds provided in interstices between mating parts of an assembled slicer and/or conveyor subassemblies, thereby completely and permanently filling voids contained therebetween.

In another arrangement, an antimicrobial agent delivery assembly 1131 is provided, such as inserted inside the housing via a sidewall opening 1030, which delivers an antimicrobial agent to interior wall surfaces of the housing, the blade, and/or the exterior of the sleeve 1002. The antimicrobial agent delivery assembly may be, for example, an antimicrobial liquid chemical sprayer or fogger (e.g., a peroxide fogger), an antimicrobial gas dispenser (e.g., an ozone dispenser), a steam dispenser, or hot air dispenser. It also may be a device which emits microbial-controlling radiation, such as ultraviolet lights, infrared lamps, or laser beam sources. Conductive thermal heaters also may be thermally connected to the housing to deliver thermal energy directly to the housing parts sufficient to heat them up to a temperature which may reduce or inhibit microbial loads thereon. These microbial load controlling measures may be used individually or in combinations thereof.

Referring to FIG. 9, in one alternative at least a portion of the sleeve 1029 extends into the interior space 1008 of the housing 1011 has a construction which transmits radiant energy, such as laser light, ultraviolet light, infrared radiation, and so forth, emitted from a radiant energy source, such as source 1131 (FIG. 7), from outside the sleeve 1029 through its radial thickness to the outer surface of a food product 1001 passing through the sleeve 1029. The radiant energy transmitting construction of the sleeve 1029 may be selected from suitably shaped, molded or cast plastics, ceramics, and glasses which have suitable optical properties for this purpose.

In one particular embodiment, the sleeve 1002 (or sleeve 1029) has channels formed in the interior of the sleeve that provide access to the food product log in the sleeve 1002, 1029 for a fluid or flowable material to treat the outer surface of the food product as the product is advanced through the sleeve. The fluid has properties selected for treating the outer surface of the food product. In one particular embodiment, the fluid material is a source of thermal energy, such as steam or hot air. In another particular embodiment, the fluid comprises a gaseous antimicrobial chemical substance, such as ozone gas.

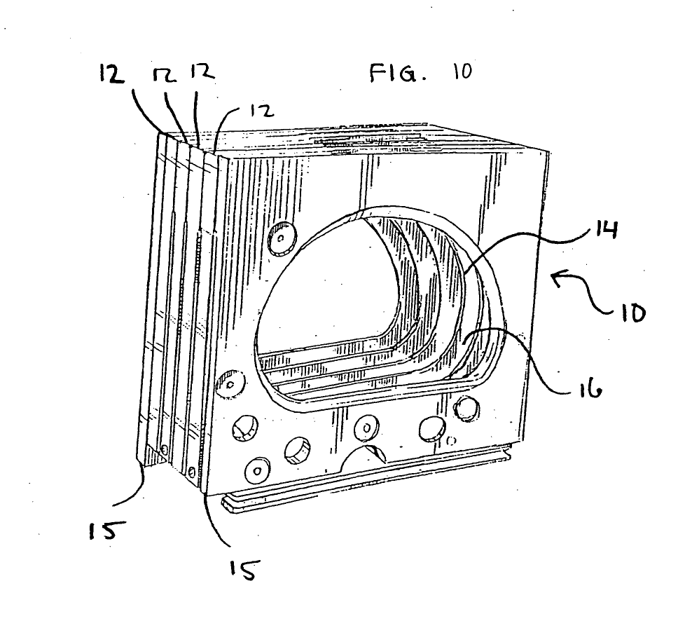

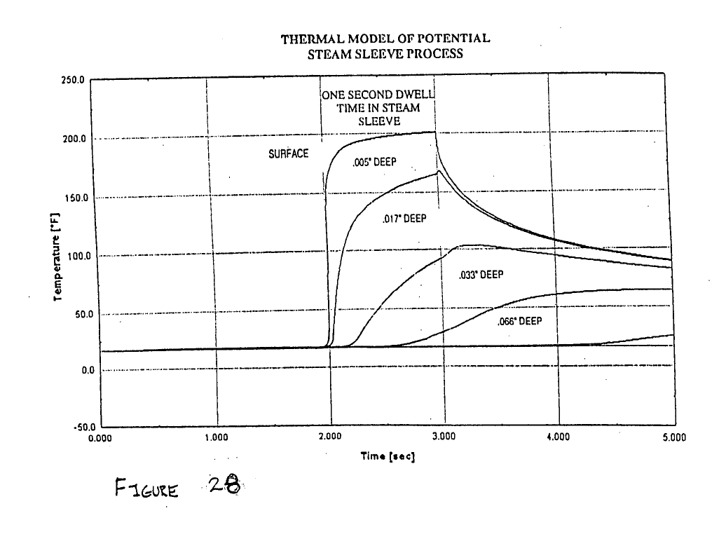

For instance, as illustrated in FIGS. 10-29, a treatment sleeve 10, 100 or 200 is provided having an entrance opening 101 and an exit opening 102 spaced along the axial length of the sleeve of (e.g., see FIGS. 17, 19). The axial length of the sleeve is relatively short, e.g., on the order of about 3 to about 10 inches in length. These treatment sleeves, for purposes of this discussion, may be used as sleeve 1002 or 1029 which is mounted in a sidewall of a slicer housing as discussed supra. Formed between the entrance opening and the exit opening of the treatment sleeve 10, 100 or 200 and in an interior thereof are a plurality of channels 16, 110 and 120 or 210 and 211. The channels 16, 110 and 120 or 210 and 211 and the entrance opening and exit opening are configured such that when a food product log 5 is traveling axially through the treatment sleeve 10, 100 or 200, the outer surface of the food product 5 is exposed to the channels 16, 110 and 120 or 210 and 211. Treatment fluid is circulated through the channels 16, 110 and 120 or 210 and 211, thus coming into contact and treating the outer surface of the food product 5.

The fluid used within the treatment sleeve 10, 100 or 200 is preferably steam. The steam is supplied to the channels 16, 110 and 120 or 210 and 211 for circulation via inlets and outlets for the channels. The steam is preferably delivered with desired properties, such as saturated at a particular pressure or at a predetermined temperature, into the channels 16, 110 and 120 or 210 and 211 effective to treat the outer surface of the food product by facilitating heat transfer from the steam to the outer surface of the food product 5.

As the steam contacts the outer surface of the food product 5, some of the steam may condense and impart a large amount of heat to the product surface, but also form a layer of insulating condensate. The condensate has a lower heat transfer rate as compared to the condensing steam. To remove condensate from contact with the outer surface of the food product 5, the steam is preferably circulated through the channels 16, 110 and 120 or 210 and 211 with a generally predetermined velocity to create sufficient circumferential forces to draw the condensate away from the outer surface of the food product 5 and toward walls of the channels 16, 110 and 120 or 210 and 211.

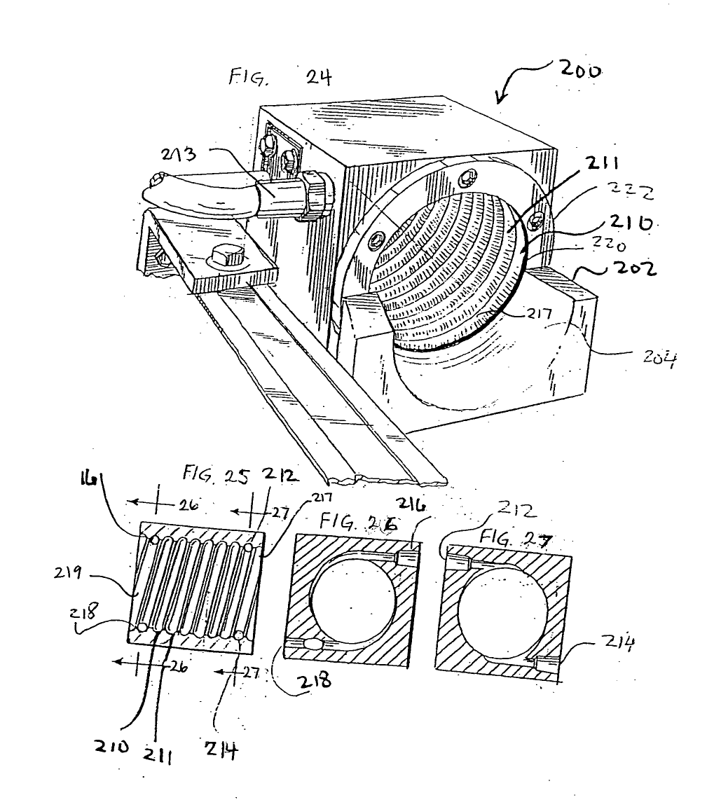

The channels 16, 110 and 120 or 210 and 211 define flow paths for the steam. The flow path is preferably of a length selected to limit the amount of pressure drop and/or velocity reduction of the steam to ensure sufficient heat transfer from the steam to the outer surface of the food product 5 during treatment. In one embodiment, illustrated in FIGS. 10-13, each generally planar channel 16 makes generally about one revolution around the interior of the treatment sleeve and thus has a generally short flow path. In another embodiment, illustrated in FIGS. 24-27, a pair of helical flow channels 210 and 211 extend multiple times around the interior of the treatment sleeve 200 while advancing from the exit opening to the entrance opening of the sleeve 200, thus having a longer flow path than the flow path of FIGS. 10-13. In yet another embodiment, illustrated in FIGS. 17-23, two helical channels 110 and 124 are formed around the interior of the treatment sleeve 100. The treatment sleeve 100 of FIGS. 17-23 is longer than the treatment sleeve of FIGS. 24-27. However, the use of multidirectional flow within each of the helical channels 110 and 120, as will be discussed in greater detail below and as opposed to the unidirectional helical flow channels 210 and 211, reduces the overall flow channel lengths 110 and 120 to minimize the amount of pressure drop/velocity reduction of the steam to ensure sufficient heat transfer from the steam to the outer surface of the food product 5 to treat the outer surface.

One or more wiper elements 14 and 220 are provided either in the interior of the treatment sleeve 10 or adjacent the entrance and/or exit openings of the treatment sleeve 10 and 200. The wiper elements 14 and 220 define an opening therethrough that is sized to be smaller than the entrance or exit opening of the treatment sleeve 10 and 200. In one aspect, the opening of the wiper element 14 and 220 may be sized to be smaller than the size the food product log 5 about the outer surface thereof so as to be in interference therewith as the log travels through the sleeve. In this manner, as the food product 5 is advanced through the interior of the treatment sleeve 10 and 200, the portion of the wiper 14 and 220 adjacent the wiper opening is in contact, or close to being in contact, with the outer surface of the food product 5. The wiper 14 and 220 is preferably made of a flexible, resilient material and functions to substantially maintain the steam within the treatment sleeve 10 and 200, maintain desired flow characteristics and prevent unnecessary decreases in the temperature within the treatment sleeve 10 and 200, and, if in contact with the outer surface of the food product 5, to wipe away any excess condensate on the surface of the food product 5.

The food product 5 is advanced through the treatment sleeve 10, 100 or 200 while the steam is circulating through the one or more channels 16, 110 and 120 or 210 and 211 in a generally continuous operation. By advancing the food product 5 through the treatment sleeve 10, 100 or 200 in a generally continuous operation, food processing efficiency can be improved compared to systems where a food product is advanced intermittently through a sealed steam chamber having doors or other barriers that must be opened and closed with each steam cycle.

The length of the treatment sleeve 10, 100 and 200 and the advancement rate of the food product 5 combine to provide a dwell time, which is the amount of time the food product is in contact with the steam in the treatment sleeve. The dwell time and the heat transfer rate due to the steam applied to the outer surface of the food product 5 combine to determine the amount of heat transferred from the steam to the food product 5 while the food product 5 is advancing through the treatment sleeve 10, 100 and 200.

The steam transfers heat to the food product 5 and by conduction permeates the food product 5 to various depths, depending upon the dwell time and the heat transfer rate due to the steam. A one second dwell time, as illustrated in the predicted thermal model of FIG. 24, results in elevated temperatures on the surface and very close to the surface sufficient to treat the surface, while not permeating very deeply into the food product 5. Thus, the majority of the body of the food product log 5, which is disposed radially inwardly from the outer surface of the food product 5, is not subject to substantially elevated temperatures. This contributes to minimal changes in the texture and appearance of the food product 5 as compared to a food product not advanced through the treatment sleeve 10, 100 or 200. In addition, not substantially elevating the temperature of the body of the food product log 5 below the surface thereof results in a relatively fast cool time for the product 5 to return to its original thermal state after leaving the treatment sleeve 10, 100 or 200. The dwell time within the sleeve, and the temperature of the fluid, are preferably selected to allow for optimized slicing of the food product when used upstream of a slicing station. For example, if the food product is raised to too high of a temperature and at too deep of a depth, slicing can be difficult, and tearing of the food product may result. Tearing can be undesirable in certain applications where the aesthetic appearance of the sliced food product is adversely affected.

As illustrated in FIG. 28, the temperature on the surface of the food product 5 is predicted to be between about 150° F. and 200° F. after a one to three second dwell time within the sleeve as the product has been advanced therethrough. Moving inwardly within the food product 5 from the surface thereof about 0.005 inches, the temperature is predicted to be between about 150° F. and about 200° F. Moving further inward to about 0.017 inches, the temperature is predicted to be between about 75° F. and about 125° F. Even further inward of the outer surface of the food product 5 to about 0.033 inches, the temperature is predicted to be between about 25° F. and about 75° F. Thus, the temperature on the outer surface of the food product 5 is highest, and then the temperature rapidly decreases the further inward from the outer surface of the food product 5.

Turning now to more of the details of the various aspects of the treatment sleeves 10, 100 and 200, the sleeve 10 illustrated in FIGS. 10-13 has generally D-shaped entrance and exit openings, while the sleeves 100 and 200 illustrated in FIGS. 17-27 have generally circular entrance and exit openings 101, 102 (e.g., see FIGS. 17, 19). Other openings, such as rectangular and square, may also be used, depending upon the profile of the food product.

The openings of the treatment sleeves 10, 100, and 200 are configured based on the profile of the food product 5 for which it is associated. For example, meat products comprising bologna and sausage are generally circular shaped in profile and consistently have similar sized profiles. Due to the relatively consistent sizing of the circular-profiled food products 5, the size of the treatment sleeve 100 and 200 entrance and exit openings is sized slightly larger than the size of the food product profile. Other meat products, such as ham, are allowed to naturally settle in their casings, resulting in a generally D-shaped profile, having a flattened bottom. Due to the natural settling, there can be variances in the size of the resulting D-shaped profiles. To accommodate the variances in food product profiles, the D-shaped openings are sized less closely to the product profiles than the generally circular openings. To further accommodate various sizes of D-shaped openings, the corresponding wiper elements 14 are larger in size. Therefore, when there is a smaller D-shaped food product 5 advancing through the treatment sleeve 10, the wiper 14 contacts or closely contacts the outer surface thereof with little or no flexing. When a relatively larger D-shaped food product 5 is advancing through the treatment sleeve 10, the wiper 14 flexes to accommodate the size while still contacting the outer surface of the product 5. The treatment sleeve 10 having the D-shaped entrance and exit openings, illustrated in FIGS. 10-13, is formed of a plurality of abutting plates 12 and 15. As illustrated, there are four channel plates 12 between a pair of face plates 15. A wiper element 14 is positioned between each of the plates 12 and 15. The wiper elements 14 have an opening smaller than the entrance and exit openings, and thus project radially inward beyond the interior surfaces 22 of the channel plates 12 to define the flow channels 16. The face plates 15 are provided to secure the wipers 14 to the adjacent channel plates 12 proximate the entrance and exit openings of the treatment sleeve 10.

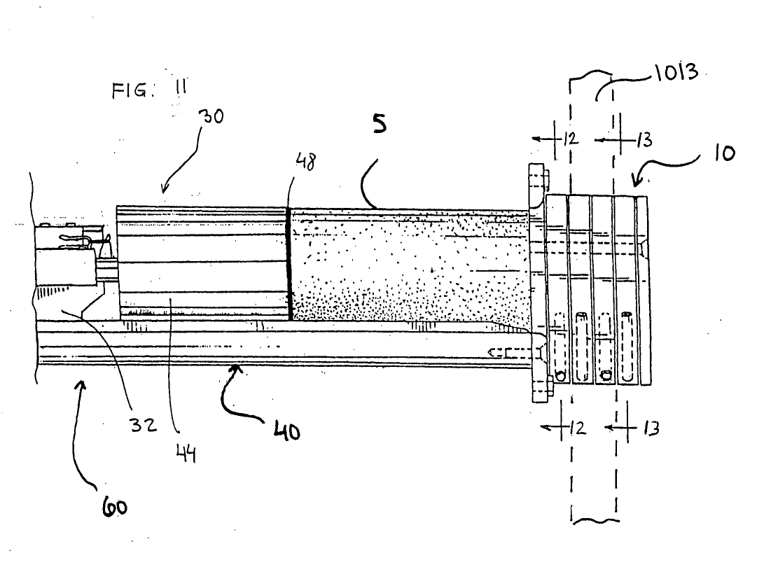

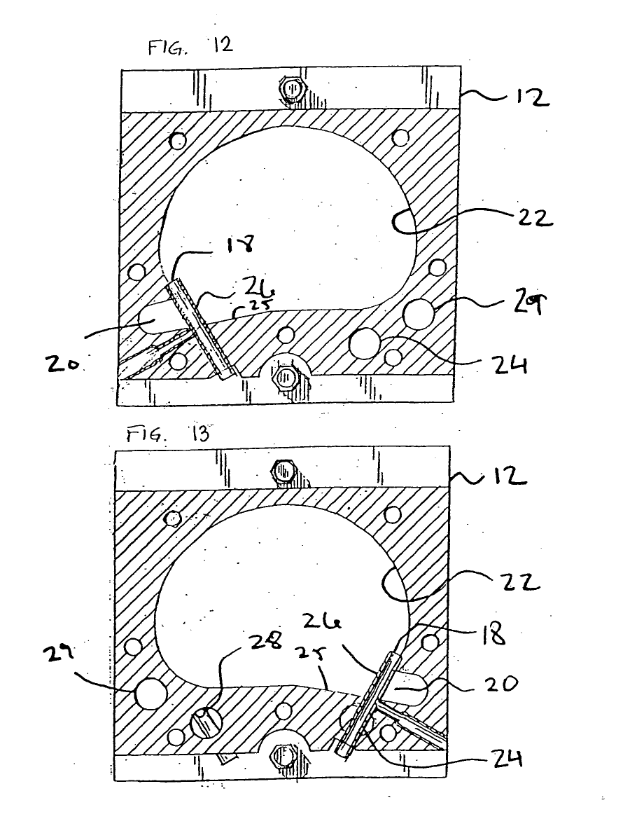

As illustrated in FIGS. 12 and 13, each of the plates has a fluid inlet 18 and a fluid outlet 20. The fluid inlet 18 includes a nozzle 26 aimed to direct the fluid flow generally tangentially to the flow direction around the interior surface 22 of the channel 16. The nozzle 26 is in fluid communication with inlet conduits 24 which comprises fluid passages between adjacent plates via a nozzle inlet 28. In close proximity to the fluid inlet 18 is the fluid outlet 20, positioned to allow fluid to exit the channel 16 after approximately a single revolution around the interior surfaces 22 of the plate 12. The interior surfaces 22 of the channel 16 adjacent the fluid outlet 20 include downwardly inclined surfaces 25 directed toward the outlet 20 to facilitate drainage of any condensate. Similar to the fluid inlet 18, the fluid outlet 20 is in fluid communication with outlet conduits 29 extending between adjacent plates 12 and 15. A fluid inlet port for introducing steam or other suitable surface treating fluid from a fluid supply into the inlet plumbing 24 of sleeve 10 may be conveniently provided in fluid communication with one or more of the sleeve plates which are located outside the slicer housing with the sleeve mounted to the housing sidewall.

The plates 12 are arranged such that the fluid flow in each respective channel plate 12 alternates between clockwise and counterclockwise. For example, in the first channel plate 12 closest to the entrance opening of the sleeve the fluid flow is in a clockwise direction relative to the exit opening. The next channel plate 12 has a counterclockwise fluid flow, followed by a plate 12 with a clockwise fluid flow, and finally a plate 12 with a counterclockwise fluid flow. The widths of the plates 12 and 15 are selected to minimize the amount of space that the treatment sleeve 10 occupies on the food processing equipment. The plates 12 and 15 are each preferably about 0.25 inches in width, resulting in a total axial length of the treatment sleeve 10 of about 3 inches.

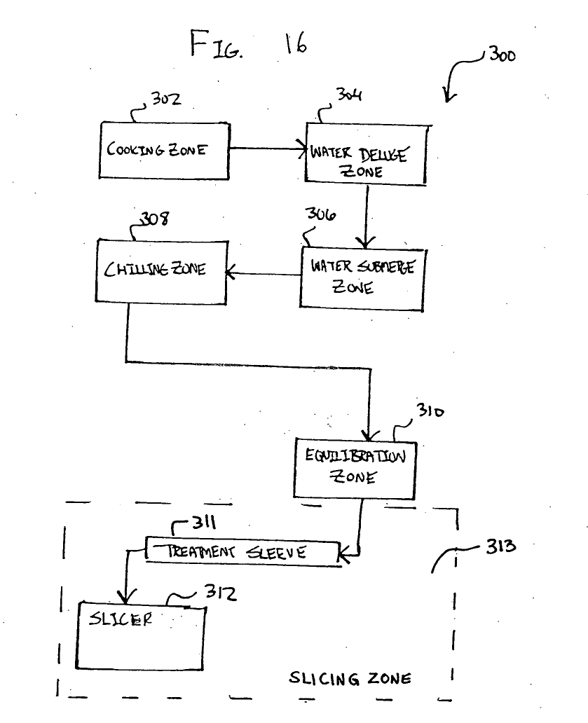

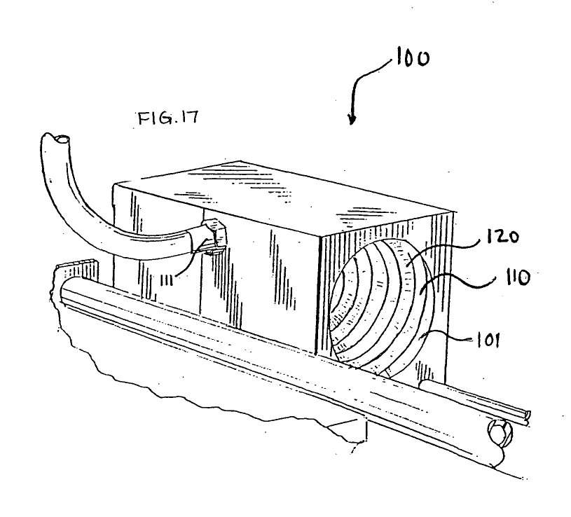

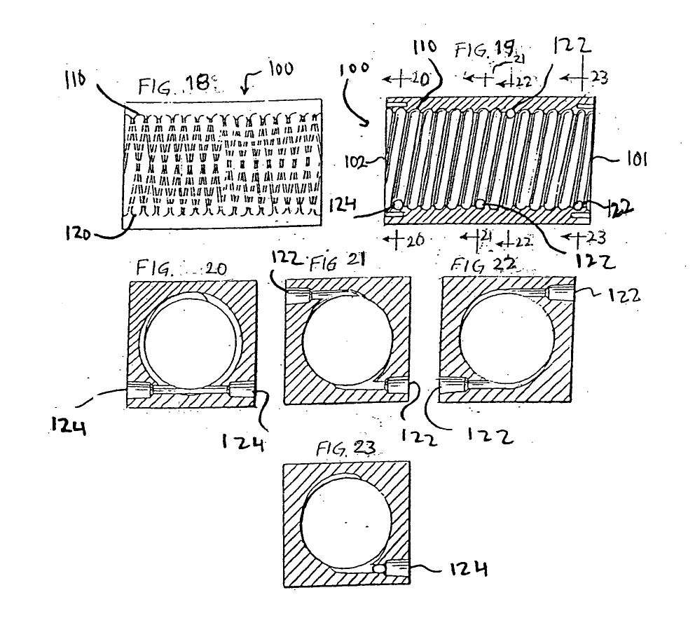

The treatment sleeve 100 illustrated in FIGS. 17-13 has a pair of helical flow channels 110 and 120 around its interior. As shown in FIG. 18, the pair of helical flow channels 110 and 120 are configured in a double helix arrangement. Each of the helical flow channels 110 and 120 has a pair of inlets 122. The two helical flow channels 110 and 120 each share common outlets 124. The inlets 122 are positioned proximate the mid-section of the treatment sleeve 100 and the outlets 124 are positioned proximate the entrance and exit openings for each of the helical channels 110 and 120, as shown in FIG. 19. Fluid is introduced into the treatment sleeve 100 via the four inlets 122, two for each of the helical channels 1, 10 and 120, as illustrated in FIGS. 21 and 22. Because the two inlets 122 for each of the helical flow channels 110 and 120 are disposed at an axially intermediate position along the length of the treatment sleeve 100, the fluid flows along flow paths defined by each channel 110 or 120 both toward the entrance opening and toward the exit opening. At the entrance opening of the treatment sleeve 100, both channels 110 and 120 have a common exit through the fluid outlet 124, as shown in FIG. 23. At the exit opening of the treatment sleeve 100, a pair of fluid outlets 124 are provided, one for each of the helical flow channels 110 and 120, as illustrated in FIG. 20.

Turning to more of the details of the dual helix treatment sleeve 100, the sleeve 100 is configured for treating product with a diameter of about 4.25 inches. The sleeve 100 is between about 9 and 10 inches in axial length, and preferably about 9.5 inches; between about 5 and 7 inches in height, and preferably about 6 inches; and between about 5 and 7 inches in width, and preferably about 6 inches. The minor radius of the interior of the multi-directional double helix treatment sleeve 100 is between 2 and 2.3 inches, and is preferably about 2.15 inches. The major radius of the interior of the multi-directional double helix treatment sleeve 100 is between about 2.25 and 2.55 inches, and is preferably about 2.4 inches. Thus, the depth of the channels 110 and 120 is preferably about 0.25 inches. The helical channels 110 and 120 are each preferably at an 80° inclination relative to the length direction of the treatment sleeve 100, and spaced 1.25 inches apart per revolution. These dimensions are merely given by way of example, and can be readily scaled up or down, or otherwise varied, in accordance with particular sizing requirements for different profiles of food products.

Similar to the treatment sleeve 100 of FIGS. 17-23, the treatment sleeve 200 of FIGS. 24-27 has a pair of helical flow channels 210 and 211 that extend around its interior in a double helix arrangement. Each of the helical flow channels 210 and 211 has a single fluid inlet 212 or 216 and a single fluid outlet 214 or 218, as illustrated in FIGS. 25-27. One of the flow channels 211 has its inlet 212 positioned proximate the entrance opening and its outlet 218 positioned proximate the exit opening so that fluid is directed in a helical flow path from the entrance opening 217 to the exit opening 219. The other of the flow channels 210 has its outlet 214 positioned proximate the entrance opening and its inlet 216 positioned proximate the exit opening so that fluid is directed from the exit opening to the entrance opening. When the fluid is steam, the oppositely directed flow paths of the fluid in the fluid channels 210 and 211 ensures that the steam contacts the surface of the food product 5 soon after it enters and soon before it exits the treatment sleeve 200 to treat the outer surface, which also can quickly initiate desired flow. Thus, the amount of condensed steam, with reduced heat transfer properties, that may be present at either the entrance or exit openings of the sleeve 200 can be reduced. The fluid inlet port 111 for introducing steam or other suitable surface treating fluid from a fluid supply into the inlet plumbing of sleeve 100 may be conveniently provided in fluid communication with one or more of the sleeve plates which are located outside the slicer housing with the sleeve's mounted to the housing sidewall.

The details of the dual helix treatment 200 sleeve of FIGS. 24-27 are similar to the multi-direction dual helix treatment sleeve 100 of FIGS. 17-23, except that the sleeve may be between about 4.75 and 6.75 inches in length, and particularly about 5.75 inches. As discussed above, although particular scaled or otherwise modified to accommodate a variety of different food product profiles.

The treatment sleeve 200 has a wiper element 220 positioned proximate both the entrance opening and the exit opening, for the purposes discussed above in greater detail. The wiper elements 220 are attached to the treatment sleeve via annular mounting rings 222, as illustrated in FIG. 24, thereby allowing for easy removal of the wiper elements 220 for maintenance or replacement. A lead-in block 202 is attached to the treatment sleeve 200 proximate the entrance opening 217 to ensure that the food product log 5 is properly directed and guided into the interior of the sleeve 200. The lead-in block 202 has an arcuate surface 204 that tapers or tunnels toward the entrance opening to facilitate alignment of the food product 5 with the interior of the sleeve 200. The fluid inlet port 213 for introducing steam or other suitable surface treating fluid from a fluid supply into the inlet conduit of sleeve 200 may be conveniently provided in fluid communication with one or more of the sleeve plates which are located outside the slicer housing in the sleeve's mounted configuration on a housing sidewall.

The food product 5 is advanced through the treatment sleeves 10, 100 and 200 using an advancement mechanism 60. The sleeve is mounted in slicer housing sidewall 1013 (indicated by hatched lines). In this illustration, the advancement mechanism 60 comprises a longitudinally extending track 40 aligned with a longitudinal axis of the sleeve 10, as illustrated in FIG. 11. The advancement mechanism 60 further comprises a pusher device 30 movable relative to the track 40 for pushing the food product 5 along the track 40 and through the treatment sleeve 10. Various driving methods may be used for moving the pusher device 30 relative to the track 40. For example, a screw-type drive, pneumatic drive, or a chain or belt drive may be used for advancing the pusher device 30 (e.g., see assembly 1123 in FIG. 2). The rate at which the advancement mechanism 60 feeds the food product through the sleeve can be controlled via a computerized controller. The rate can be determined upon such factors as the thickness of desired slices when the food product is immediately sliced downstream of the sleeve and the desired dwell time within the sleeve. For example, a seven foot length of a food product log may be advanced through the sleeve at a rate effective to produce 2000 slices per minute of the food product when a slicing station is positioned immediately downstream of the sleeve.

The pusher device 30 includes an arm 32 for movable connection relative to the drive and the track 40 and a food product-facing pusher portion 44, as illustrated in FIGS. 14 and 15. When the pusher device 30 is advanced toward the treatment sleeve 10, the pusher portion 44 contacts traveling end of the food product 5 to push the food product 5 through the sleeve 10. The distance between the arm 32 and the pusher portion 44 is preferably selected to ensure that the pusher portion 44 is able to extend completely or at least partially through the steam sleeve 10, 100 or 200, as illustrated in FIG. 11, in order to maximize the amount of food product 5 passed through the treatment sleeve 10, 100 or 200.

The pusher portion 44 has a an annular flange member 48 of a resilient material at its engagement end positioned at one end to securely abut the end of the food product 5 The flange member 48 protrudes from the end face of the pusher portion 44 and resiliently engages and partially surrounds the trailing end face of the food product 5 in order to assist in maintaining a vacuum seal between the end of the food product 5 and the pusher portion 44. The flange member is preferably formed of a resilient plastic or rubber material suitable for contact with food products, and is inserted into a groove formed 148 formed on the face of the pusher portion 44 abutting the food product 5.

The pusher portion 44 also has an aperture 49 connected to a vacuum assembly 46 for further securing the food product 5 to the pusher 30 when vacuum is applied. The vacuum assembly 46 comprises a hollow shaft 143 having the pusher portion 44 mounted at one end thereof. A gasket 145 is positioned between the pusher portion 44 and the hollow shaft 143 to reduce pressure losses when a vacuum is applied. The opposite end of the hollow shaft 143 is removably received within a bore 149 within a mounting block 147, which is secured to the arm 32. The bore 149 extends through the mounting block 147, as shown in FIG. 15. One end of the bore 149 has a diameter sufficient to receive the hollow shaft 143, and a gasket 151 is positioned therebetween to reduce pressure losses when a vacuum is applied. The other end of the bore 149 has a different diameter than the first end, and has a vacuum connection 153 permanently received therein. A step 155 is located within the bore 149 where the bore changes diameters to provide a stop for fixing the relative position between the hollow shaft 143 and the mounting block 147. When a vacuum is applied via the vacuum connection 153, the pressure drop continues through the bore 149, through the hollow shaft 143, and through the aperture 49 formed in the end of the pusher portion 44 facing the food product 5. A screen 157 is positioned within the aperture 49 to restrict portions of the food product 5 from entering the hollow shaft 143 when the vacuum is applied. The face of the pusher portion 44 abutting the food product 5 is configured with a pair of concentric raised rings 162 and 164 projecting axially beyond flange 48. The rings 162 and 164 each have multiple notches formed therein. When vacuum is applied to draw the food product 5 against the pusher portion 44, the rings 162 and 164 assist in evenly distributing the vacuum forces along the trailing face of the food product 5. In particular, the raised rings 162 and 164, along with the flange member 48, can allow for food products 5 having variations in the trailing face surface to be securely maintained against the pusher portion 44 when a vacuum is applied.

The pusher portion 44 may be sized and shaped to closely fit within the opening of the wiper elements 14 in order to assist in maintaining the desired flow characteristics of the fluid as the pusher portion 44 drives the food product 5 through the steam sleeve 10, 100 or 200. For example, if the food product has a D-shaped profile, the pusher portion may have a corresponding D-shaped profile. The pusher portion 44 is attached to the pusher 30 via threads, so that the pusher portions can be easily interchanged and cleaned.

The pusher portion 44, along with the hollow shaft 143, are configured to be removable from the mounting block 147 in order to allow for cleaning and replacement with pusher portions 44 having different sizes and profiles. A protruding securement element 161 is attached to the shaft 143, as shown in FIGS. 14 and 15. The securement element 161 has a notch 165 for receiving a free end of a clamp 167. An end of the clamp 167 opposite the free end is secured to a clamp actuator 163. The clamp actuator 163 is movable between a disengaged position allowing for the free end of the clamp 167 to be removable from and insertable into the notch 165 of the securement element 161 and an engaged position securing the clamp 167 in the notch 165 of the securement element 161 to secure the pusher portion 44 and shaft 143 relative to the mounting block 147.

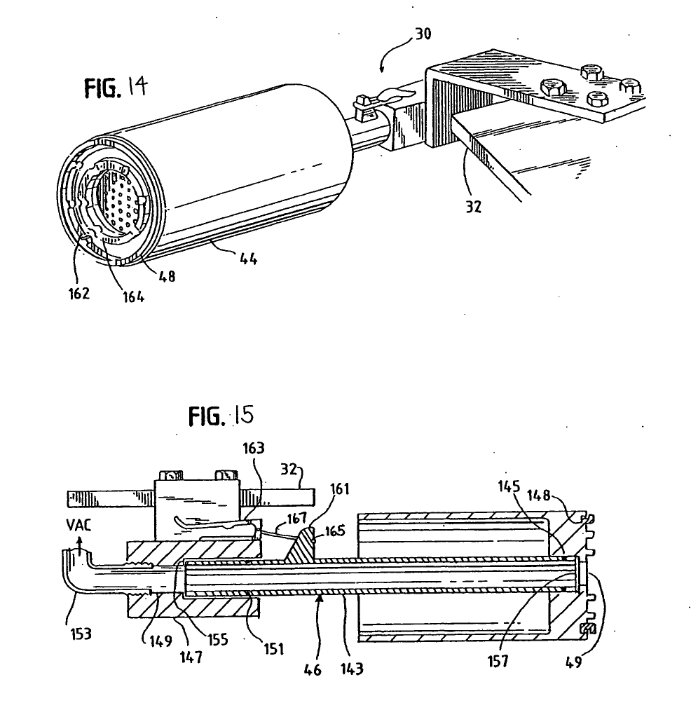

The steam sleeve 10, 100, 200 may be mounted in the housing sidewall of a slicer used in a commercial-scale food processing operation 300. Referring to FIG. 16, the commercial food processing operation may proceed through multiple treatment areas before reaching a slicing zone 313, i.e. the slicing zone in which the above-described slicing apparatus 1000 is operated. The treatment areas where the food product is subjected to different treatments can include a cooking zone 302, a water deluge zone 304, a water submergence zone 306, a chilling zone 308, an equilibration zone 310, and the slicing zone 313. The treatment sleeve treatment zone 311 is used to advance the food product from outside-to-inside a slicer housing to slicer 312 using constructions and arrangements such as described variously above in FIGS. 10-14. The sleeve 10, 100 or 200 also may be used in a separate earlier sleeve treatment zone 309 after the chill zone 308 and prior to the equilibration zone 310. However, the sleeve 10, 100 or 200 can be used between or as part of other operations.

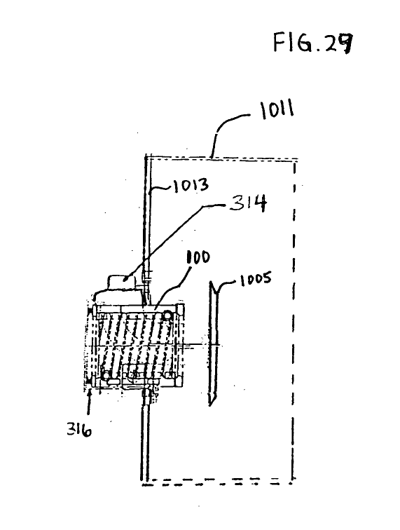

Various other equipment can be used with the sleeve 10, 100 or 200 during the food processing operation 300. For example, a steam hood 314 can be positioned adjacent the portions of sleeve 10, 100 or 200 which are located outside a slicer housing 1011 in order to remove excess steam and/or condensate proximate the exterior of the sleeve 10, 100 or 200, as depicted in FIG. 29. The removal of excess steam and/or condensate can desirably reduce moisture levels which can contribute to microbial activity in the environment proximate the sleeve 10, 100 or 200.

A slide gate 316 may be provided at one or both of the entrance and exit openings of the sleeve 10, 100 or 200 in order to prevent the escape of steam prior to the food product 5 being fed adjacent to the gate 316. To this end, the gate 316 is configured to seal the exit opening, downstream of the entrance opening and in the feed direction, of the sleeve 10, 100 or 200 when in a closed position. The gate 316 can be shifted to an open position, such as when the food product is spanning the interior of the sleeve 10, 100 of 200 between the entrance and exit openings thereof, allowing passage of the food product 5 through the sleeve 10, 100 or 200. The gate 316 preferably is formed of a plastic, and may be an ultrahigh molecular weight plastic such as DELRIN7. The gate 316 may be slid along pins projecting from the downstream end of the sleeve, and may be controlled by a motor or an air cylinder.

The use of the gate 316 also allows for the sleeve 10, 100 or 200 to be used for treating the leading end face of the food product 5, such as when the food product is initially being fed through the entrance opening of the steam sleeve and the gate 316 is in its closed position, thereby allowing for steam to leave the channels and contact the leading end face of the food product 5. The trailing end face of the food product can be treated by stopping the forward movement of the food product 5 just before the trailing face exits the sleeve, and then retracting the pusher portion 44 to briefly treat the pusher portion 44 face and the trailing end face of the food product 5. After treatment of the trailing end face of the food product 5, the trailing end face can be advanced out of the sleeve 10, 100, or 200.

As used at a slicing zone 313, the steam sleeve 10, 100 or 200 is mounted in the slicer housing sidewall 1013 immediately adjacent the slicing blade 1005, as illustrated in FIG. 29, in order to minimize spacing between the exit opening of the sleeve 10, 100 or 200 and the slicing apparatus and thus minimize exposure of the food product 5 prior to slicing.

The products that may sliced by the apparatus and methods of embodiments described herein include, but are not limited to, boneless food product formed into elongated structures, such as logs, loaves, sticks, and the like. These food products may comprise, for example, elongated food products made with beef, pork, fowl, fish, such as sausages, bologna, luncheon meat, formed roasts products such as roast loaf, shaped ham products such as ham loaf, and the like.

While the invention has been particularly described with specific reference to particular embodiments, it will be appreciated that various alterations, modifications and adaptations may be based on the present disclosure, and are intended to be within the spirit and scope of the present invention as defined by the following claims.

What is claimed is:

1. A food product slicing apparatus comprising:
a housing enclosing a slicing device, wherein the slicing device comprises a rotatable slicing blade, and wherein the housing comprises a sidewall; and
a sealing and cleaning structure comprising a sleeve mounted to the sidewall, providing a passageway in the sidewall through which the food product passes and receives a treatment along its outer surface.

2. The apparatus of claim 1, wherein the sleeve has a cross-sectional shape adapted to conform to the cross-sectional shape of a preselected elongated food product.

3. The apparatus of claim 1, wherein the housing comprises a front sidewall and a rear sidewall, and an enclosure formed by the front and rear sidewalls which surrounds the slicing blade, with the sleeve being mounted in the front sidewall.

4. The apparatus of claim 3, further comprising a hinged connection between the front sidewall and rear sidewall.

5. The apparatus of claim 3, wherein the front sidewall and rear sidewall comprises interior wall surfaces having a surface finish (RMS) not exceeding 32 microinches.

6. The apparatus of claim 3, wherein the rear sidewall includes a discharge opening adapted to receive a slice stacker.

7. The apparatus of claim 6, further comprising a paddle stacker located adjacent to the discharge opening for receiving slices cut from the food product by the slicing blade, and a stack conveyor adapted to receive thereon stacks of sliced product collected and transferred by the stacker.

8. The apparatus of claim 3, further comprising an antimicrobial agent delivery assembly operable to deliver an antimicrobial agent to interior wall surfaces of the front sidewall and rear sidewall.

9. The apparatus of claim 8, wherein the antimicrobial agent delivery assembly is selected from the group consisting of an antimicrobial liquid chemical sprayer, an antimicrobial gas dispenser, ultraviolet lights, infrared lamps, lasers, a steam delivery assembly, a hot air delivery assembly, conductive heaters, individually or in combination thereof.

10. The apparatus of claim 1, further comprising a food product advancement assembly operable to push a longitudinal end of the food product in a substantially horizontal direction to advance the food product through the sleeve and towards the slicing blade.

11. The apparatus of claim 1, further comprising a gas source operable to feed gas inside the housing to provide a positive pressure environment within the housing.

12. The apparatus of claim 11, further comprising a HEPA filter operable to filter the gas supplied by the gas source before the gas is introduced into the housing.

13. The apparatus of claim 1, wherein at least a portion of the sleeve extends into an interior space of the housing, having a construction which transmits radiant energy received from a radiant energy source located outside the sleeve to the outer surface of a food product passing through the sleeve.

14. The apparatus of claim 13, wherein the radiant energy source is selected from the group consisting of a laser light source, an ultraviolet light source, and an infrared radiation source.

15. The apparatus of claim 1, further comprising a pushing device also is provided outside the slicer housing for pushing the meat log, and a guiding device for guiding the meat log, towards and through the sealing and cleaning structure into the slicing region of the slicing apparatus.

16. A food product slicing apparatus comprising:
a housing enclosing a slicing device, wherein the slicing device comprises a rotatable slicing blade, and wherein the housing comprises a sidewall; and
a food product introducing structure associated with the sidewall, providing a means through which the food product is advanced into the slicing housing; and
means for improving or sustaining cleanliness inside the slicer housing selected from the group consisting of:
a) a gas source operable to feed gas inside the housing to provide a positive pressure environment within the housing,
b) a gas source operable to feed HEPA-filtered gas inside the housing;
c) the housing comprises interior wall surfaces having a surface finish (RMS) not exceeding 32 microinches,
d) an antimicrobial agent delivery assembly operable to deliver an antimicrobial agent to interior wall surfaces of the front sidewall and rear sidewall,
e) a sealing structure comprising a sleeve mounted to the sidewall, providing a passageway in the sidewall through which the food product passes and receives a treatment along its outer surface, and
f) any combination of a), b), c), d), e), and f).

17. A method for slicing a food product, comprising:
a) providing a housing enclosing a slicing blade, and the housing having a sidewall in which a sleeve is mounted for passing a food product wherein the sleeve is operable to treat the outer surface of the food product;
b) placing a food product having an outer surface on an advancement mechanism;
c) advancing the food product in a feed direction into the sleeve using the advancement mechanism;
d) treating the outer surface of the food product as the food product passes through the sleeve;
e) advancing the food product into a slicing path of the slicing blade.

18. The method of slicing a food product in accordance with claim 17, wherein the food product comprises an elongated food product.

19. The method of slicing a food product in accordance with claim 18, wherein the elongated food product is selected from the group consisting of sausages, bologna, luncheon meat, roast loaf, and ham loaf.

20. The method of slicing a food product in accordance with claim 17, further comprising preselecting a cross-sectional shape for the sleeve which is approximately the same as a cross-sectional shape of the food product.

21. The method of slicing a food product in accordance with claim 17, further comprising feeding a gas inside the housing to provide a positive pressure environment within the housing.

22. The method of slicing a food product in accordance with claim 17, further comprising extending at least a portion of the sleeve into an interior space of the housing having a construction which transmits radiant energy received from a radiant energy source.

23. The method of slicing a food product in accordance with claim 22, wherein the radiant energy source is selected from the group consisting of a laser light source, an ultraviolet light source, and an infrared radiation source.

24. The method of slicing a food product in accordance with claim 23, further comprising filtering the feed gas with a HEPA filter before the gas is introduced into the housing.

25. The method of slicing a food product in accordance with claim 17, further comprising providing the housing as including a front sidewall in which the sleeve is mounted, and a rear sidewall, which together form an enclosure partly surrounding the slicing blade.

26. The method of slicing a food product in accordance with claim 25, further comprising providing the front sidewall and rear sidewall having interior wall surfaces having a surface finish (RMS) not exceeding 32 microinches.

27. The method of slicing a food product in accordance with claim 25, further comprising delivering an antimicrobial agent to interior wall surfaces of the front sidewall and rear sidewall via an antimicrobial agent delivery assembly.

28. The method of slicing a food product in accordance with claim 27, wherein the antimicrobial agent delivery assembly is selected from the group consisting of an antimicrobial liquid chemical sprayer, an antimicrobial gas dispenser, ultraviolet lights, infrared lamps, lasers, a steam delivery assembly, a hot air delivery assembly, conductive heaters, individually or in combination thereof.

29. The method of slicing a food product in accordance with claim 25, further comprising receiving slices cut from the food product by the slicing blade on a paddle stacker located adjacent to a discharge opening provided in the rear sidewall, and transferring stacks of sliced product collected by the stacker on a stack conveyor, wherein the advancement mechanism pushes the food product via a longitudinal end thereof in a substantially horizontal direction to advance the food product through the sleeve and towards the slicing blade.
